(19) United States
(12) Patent Application Publication
(10) Pub. No.: US 2026/0329381 A1
(43) Pub. Date: Oct. 22, 2026

(54) Systems and Methods for Analyzing, Storing, Sharing and Generating Haptic Data

(71) Applicant: Ali Israr, Bothell, WA (US)

(72) Inventor: Ali Israr, Bothell, WA (US)

(21) Appl. No.: 19/565,455

(22) Filed: Mar. 12, 2026

Related U.S. Application Data
(60) Provisional application No. 63/772,571, filed on Mar. 16, 2025.

(51) Int. Cl. G06F 3/01

(52) U.S. Cl. CPC G06F 3/016

(57) ABSTRACT

A device that renders a single channel vibration, multichannel vibrations, or multichannel pressure. The device is interconnected with the cloud and loads databases and patterns, receives commands and sends data and commands via established two way communication. The device uses programmable firmware to enable these functions.

### CROSS REFERENCE TO RELATED APPLICATIONS

This application claims priority to U.S. Provisional Patent application 63/772,571, filed Mar. 16, 2025, which is hereby incorporated by this reference as if fully set forth herein.

### TECHNICAL FIELD

This disclosure relates to analyzing, storing, sharing and generating haptic data. More particularly it relates to system and processes to analyze, store, share and generate haptic data (or media) with other multimodal media (such as video, audio, hand+eye tracking and the like), context (applications), and user-in-the-loop.

### BACKGROUND

Haptics is the physical data in the environment that a user senses through the skin, joints, tendons, muscles, and the like and characterized by both cutaneous (pressure, skin stretch, warmth, and the like) and kinesthetic (forces and body movements) sensory systems. Haptic sense is active when a user presses and/or slides (i.e. user actions) an object or part of the object, and the reactive (inertial, stiffness, thermal, and the like) and/or resistive (friction, braking, and the like) forces are applied by the object to the user. This feedback is important for the user to handle and manipulate object states (such as position, shape, form, and the like) in real, virtual or remote environment settings. Haptic sense is passive when the user feels reactive forces without voluntary body movements. This feedback is important for the user to know their environment and activities in the environment (e.g. a bug crawling on the back or arm, cold windy day, a guide holding a visually-impaired user to cross a busy road, and the like). FIG. 11 shows a definition of haptic data and primitive components of mechanical interactions on the hand.

### DISCLOSURE

Overall, the disclosed system has a HW component and a SW component, as shown in FIG. 1. These components are put together to build applications that are used in robotics, spatial computing, XR, healthcare, communication, and entertainment platforms.

The HW component consists of haptic sensors, to sense and track haptic data from the environment and the user, and haptic actuators to generate haptic data that the user feels to augment their sensory experience. This sensor-actuator assembly can be used as an independent unit or arranged in multichannel configuration in a device arranged as grids, arrays or an arbitrary configuration.

There are at least two alternate embodiments of the haptic sensor-actuator assembly, i) where motors are placed in soft-plastic casings and stuck in pockets close to the contact surface, and ii) the motors in casings are placed inside the spring to maintain seat shape while providing comfortable compliance. A surface sensor (could be a single sensor) in the seat measures user context, their identity and physiological metrics to control haptic patterns. Also, health sensors measure vital signs and indicate instructional cues to get user's attention and set reminders.

Each actuator and sensor module is controlled by a driver or drivers (consisted of amplifier, memory, processor, digital-to-analog converters, pulse-width-modulation, and/or similar circuitries) to filter the raw sensor inputs, convert them to higher-order primitives data, convert the data into digital data, store and process the data locally, and/or move the data to another system using serial (i2c, UART, i2s, and the like) or network (Wi-Fi, Bluetooth, ethernet, and the like) communication protocols to the cloud and internet, and render real-time driving signal data.

The SW component consists of i) driver protocols to connect sensor and actuator drivers with rest of the software functions, other devices and network drivers, ii) an artificial agent optimized to process, infer, control, and generate haptic data, called Agent Hayward, and iii) an API to give users and applications access to the haptic device, the haptic data, and the haptic agent. In addition, the SW component has access to iv) a haptic database that contains calibrated data from haptic devices (actuator and sensor), user perception data (psychophysical models), user action data for completing a library of tasks, device data related to semantic description of experience, and the like

Applications of our device are in wearables such as wristbands/watches, rings, gloves, palm-band, arm-patch or band, vests, harness, belts, shows, and the like, in peripherals such as pen, controller, mouse, and the like as well as in furniture and architecture, such as in beds, sofas, chairs, vehicle seats, theater and show seats, rides, massage chairs, and the like.

### BRIEF DESCRIPTION OF THE DRAWINGS

FIG. 1: Flow of haptic information in a multimodal system

FIG. 2a: Configuration of haptic actuators and haptic sensors packaged in soft foam structure

FIG. 2b: Schematic of a method to fabricate haptic actuators and haptic sensors is a soft foam assembly

FIG. 2c: Graphical schematic of 3D magnetic flux as a function of deformation penetration in perpendicular and lateral directions

FIG. 2d: Tabular outcome display of a convolution neural network

FIG. 3: Schematic multidimensional configuration of disclosed devices

FIG. 4: Schematic multichannel configuration of the chair devices

FIG. 5: Flowchart of haptic information

FIG. 6: Schematic illustrations of a neural network model

FIG. 7a: Flowchart of Haptics Generative Model for audio streams

FIG. 7b: Flowchart of audio to spatial haptics translation scheme

FIG. 7c: Flowchart of events mapped to haptics patterns

FIG. 8a: Flowchart of Haptics Generative Model for video streams

FIG. 8b: Flowchart of Haptics Generative Model for video streams

FIG. 8c: Flowchart of Haptics Generative Model for video streams

FIG. 9: Schematic graphical illustration of models in haptic perception

FIG. 10a: Process schematic flowchart of haptic content

FIG. 10b: Process schematic flowchart of haptic content

FIG. 10c: Process schematic flowchart of haptic content

FIG. 10d: Process schematic flowchart of haptic content

FIG. 11: Table of haptic primitives

### DETAILED DESCRIPTION

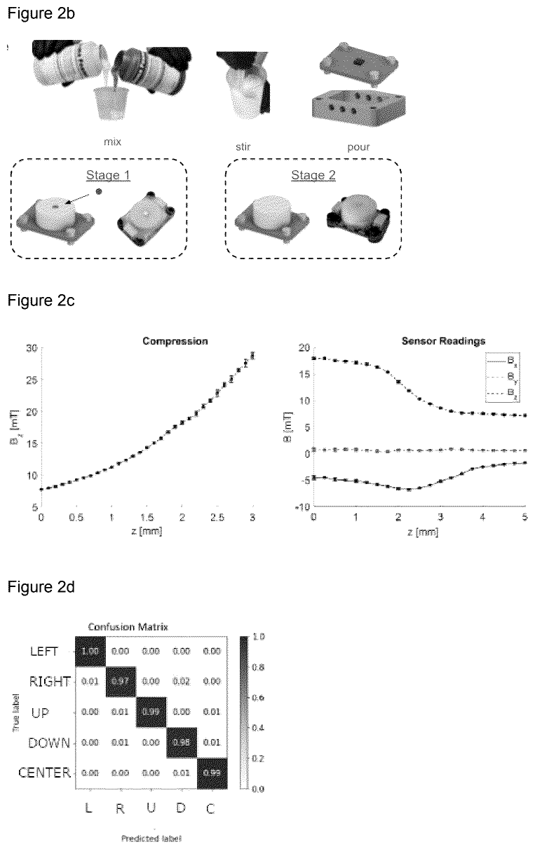

The actuator and sensors are packaged together in a device. The actuators and sensors could use the same transduction components (electromagnetic coils, piezoelectric materials, polymers and the like) or they use different transducers, one for the actuator and another for the sensor. One such implementation is shown in FIG. 2a(i), where a 3D magnetic hall effect sensor (e.g. Infineon Technologies TLV493D-A1B6) and a voice-coil actuator (model: TEAX19C01, Tectonic Elements, UK) are packed in a foam like material (e.g. Soma Foama Silicone or FreeFoam resin with DLP 3D printer). A configuration where multiple sensors and multiple actuators are assembled together in a foam packing is shown in (FIG. 2a(vii)).

The foam is casted by pouring liquid material in molds in 2 stages, FIG. 2b. In stage 1, the foam is casted above the sensor (foam body). In stage 2, the actuator is placed in the cavity and casted with a cover foam (foam cap). An alternate approach is to 3D print with photopolymer resin; In stage 1, the foam is printed above the sensor (foam body). In stage 2, the actuator is placed in the cavity and covered with the printed resin (foam cap).

In unloaded conditions, when the foam is relaxed (FIG. 2a(iii)), the magnetic actuator is at the reference displacement from the magnetic sensor. This is captured by the sensor, with reference magnetic flux in x-, y-, and z-axes (FIG. 2c). When the foam is pressed with a tensile force, the cap and body of the foam deform and move the actuator relatively closer to the sensor, thereby changing the magnetic flux in x-, y-, and z-axes (FIG. 2a(iv)). Pressing the foam at another location results in different values of the magnetic flux in x-, y-, and z-axes (FIG. 2a(v)). Also, when the foam is pressed and displaced in the xy-plane, then changes in magnetic flux exhibit a unique pattern (FIG. 2a(vi)).

The material of the foam body and foam cap are different. The cap is well suited to use the foam with Shore Hardness of 40A-60A while the body is made of softer foam with Shore Hardness up to 30A. In addition, the body of the foam is inserted with “iron dust” to increase the sensitivity of the hall effect sensor. The dust is poured into recesses casted in the foam during the casting phase, or printed as layers while 3D printed (FIG. 2a(ii)).

The thickness and concentration of the foam between the actuator and the sensor (foam body) and the foam cap is selected such that the sensitivity of the sensor is optimized for all deformation of the foam, while maintaining the perception capabilities of the actuator and to maintain soft comfortable user interaction with the foam.

The 3-axis magnetic data is processed using vector geometry and machine learning to learn a deformation model as the function of magnetic flux. FIG. 2c shows one such model of the magnetic flux and the penetrated displacement by a 10 mm indenter, roughly aligned with the center of the sensor. FIG. 2d shows the outcome of a convolution neural network (CNN) when the model is trained for Z-pressure (CENTER) and four cardinal directions along the xy-plane (LEFT, RIGHT, UP, DOWN).

The HW systems can be “multidimensional” and/or “multichannel”. In the multidimensional case (for example, where two types of motors are provided: I) vibration, and ii) pressure), more than one haptics feature is utilized. For example, a device vibrates and stretches the skin while senses skin/body vibrations and deformations. In the multichannel case, actuators and/or sensors are packaged together as arrays, grids, or in an arbitrary configuration.

“Haptic Primitives” are the basis of haptic perception in the physical world. A haptic primitive is a unit of perception in terms of physical units. FIG. 11 shows a definition of haptic primitives and corresponding physical stimuli on the skin and body.

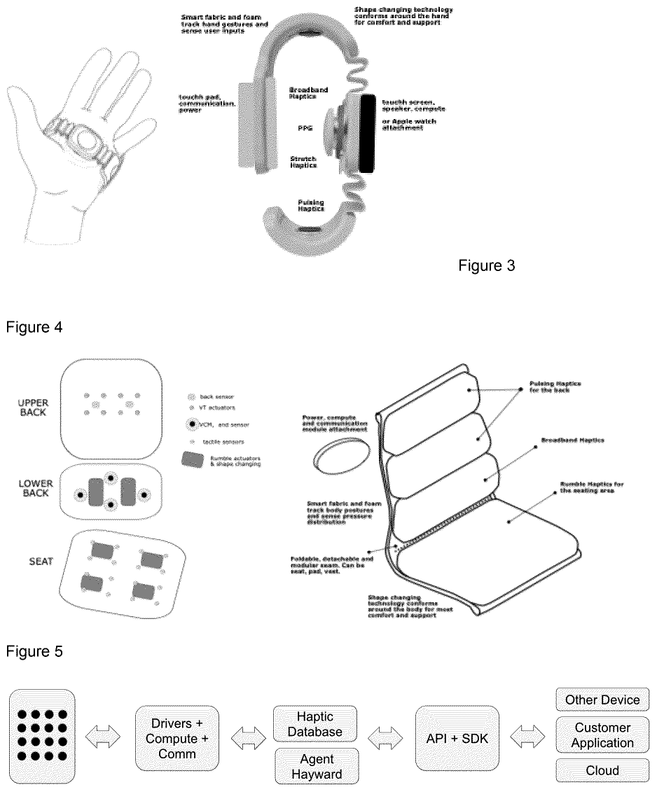

One configuration of the multimodal haptic device is a palm-band controller shown in FIG. 3. The ring is designed to conform around the hand, with an extensible spiral structure to adjust to different hand sizes and shapes. The ring on the palmar side is equipped with a broadband type voice-coil actuator (model: TEAX13C02, Tectonic Elements, UK) to play broadband vibrations (20 Hz-250 Hz) and a micromotor (stepper, dc, servo, and the like) to stretch the skin of the palm in clockwise and counterclockwise directions. This multidimensional haptic device renders the sensations of course and fine textures, button clicks, pull-push, and the like directly on the hand, while allowing the user to freely interact with real and virtual objects in mid-air or on the surface interactions. The front of the palmer ring is equipped with a tactile sensor (e.g. similar to FIG. 2), a custom touchscreen, a speaker, a microphone, an inertial measurement unit (IMU), compute unit, a photoplethysmography (PPG), or an attachment assembly for smartwatches, activity bands, projectors, cameras, and the like The ring on the palmar side is equipped with a power module and a soft tactile sensor (e.g. similar to FIG. 2) to increase comfort while consistent attachment with the hand. A set of LEDs are placed on the volar side to indicate the status of the device, and to create an ambient “aura” that changes with user states, activities or preferences. The design is made symmetric to be worn on either hand.

One configuration of the multichannel haptic device is a chair embedded with a distribution of actuators and sensors (FIG. 4). The placement and distribution of actuator and sensor assemblies (e.g. similar to FIG. 2) are optimized based on perception and ergonomic factors. For example, the density of sensors on the seat is higher than on the back of a chair in order to better recognize pressure points while sitting on a chair to guide users to sit with ergonomically correct posture or to determine number of users sitting and their sitting postures (slouching, lying, standing, and the like).

Similarly, the human's lower-body is more sensitive than the back, therefore, low-frequency (up to 60 Hz) actuators are placed in the seat to produce engine rumbles, traction force, and the like sensations, while high-frequency (>100 Hz) actuators are placed on the upper back to create localized and spatial haptic patterns (e.g. similar to FIG. 2). The spacing of these actuators are selected to create smooth phantom illusion sensations as described in [Israr and Poupyrev, Tactile Brush 2011]. Shape-changing actuators are placed to conform around the lower back and the seat to provide support (to maintain user gestures and to enable social touch interactions). Shape-changing actuators are powered using pneumatic bladders or dc servo motors.

The design of the chair device is made modular (FIG. 4b). The device could be folded from a “seam” between the seat pad and the back pad for easy handling and storage. The seam is a combination of zippers and buttons to separate the back pad from the seat pad. Power and compute units are placed on both the back pad and the seat pad to operate independently or combined as a unit. More units can be connected to either pad to extend the dynamic form of the device. The zipper can be opened from the center of the seam, allowing the head to pass through the slit and the device is worn as a vest. Each module has inertial measurement units (IMUs) for tracking movements and surface vibrations. A control interface is accessible to users to control device parameters using a small monitor screen.

Each actuator and sensor module is controlled by a driver or drivers (consisted of amplifier, memory, processor, digital-to-analog converters, pulse-width-modulation, and/or similar circuitries) to filter the raw sensor inputs, convert them to higher-order primitives data, convert the data into digital data, store and process the data locally, and/or move the data to another system using serial (i2c, UART, i2s, and the like) or network (WiFi, bluetooth, ethernet, and the like) communication protocols to the cloud and internet, and render real-time driving signal data.

Digital resolution for haptics information flow between physics and digital worlds is optimized. Due to the limited range, resolution and temporal acuity of haptic modality, drivers for haptic actuators are optimized and tested for 16-bit (>8-bit) data-types, rendering rates of 4000 Hz (>2000 Hz) for vibrations and 500 Hz (>100 Hz) for forces and movements, and allowable latency of 20 milliseconds (<80 milliseconds). These settings have shown to improve haptic experience, when accompanied with audio-visual media or during real time haptic data transmission. Processing of each haptic channel is done locally in a dedicated microcontroller which communicates with the host application with the data transmission rate of 100 Hz.

The overall flow of haptic data from the physical world to the digital world is shown in FIG. 5. The physical data from the device is converted to the digital data via drivers and amplifiers, and then passed through a haptic agent which compiles the data in a database in a defined format. A software development kit (SDK) and a library of application protocol interface (API) access the data from the haptic agent and present it to user applications, cloud applications and other devices. User or cloud applications process the data and compute command data back to the haptic agent via the API to render context-relevant haptic data in the physical world played on the device.

The haptic agent, Agent Hayward, i) processes the raw data from the sensors, ii) compiles the data in the haptic database, iii) infers the data with parametric and non parametric models to understand user states and intents, iv) combines application level information for decision making, v) learns human cognitive control models for complex tasks, actions and events, vi) transfer the raw or derived inputs to derive haptic outputs, and vi) apply generative algorithms to auto-generate haptic outputs for a class of devices.

The haptic agent takes the raw data from the physical world. It processes the raw data and arranges them into haptic primitive variables. Haptic primitives (shown in FIG. 11) are defined as the smallest unit of haptic perception defined in terms of physical units and correspond to the primitive haptic cells in the skin and body. Cutaneous (or tactile) receptors in the skin are responsible for the perception of vibrations, fine texture and impacts using Pacinian receptors (PC or P) and are represented by the symbol V. These primitives are further decomposed into cartesian coordinates measured as accelerations a_x, a_y and a_z at frequency. In the case of multi-channel arrays where several localized vibrations are measured, the measurements are represented by subscript n, where n=1, 2, 3, and the like.

Skin indentations, slip, and mechanical impedance on the skin are detected by Meissner corpuscles (rapidly adapting or RA receptors), and light touches with spatial details and coarse textures are detected by Merkel cells (slow adapting or SA-1) in the skin. These physical events are measured as f_z for a single unit, (f_z)n, where n=1, 2, 3, and the like for arrays, f_f for slip. The combined effects are represented by the primitive symbol of P. Ruffini organs in the skin are responsible for skin stretch and lateral indentations of the skin, represented by the symbol S, and measured as f_x or f_y for the single unit and with subscript n for arrays, where n=1, 2, 3, and the like Similarly other sensations, such as thermal, tickle, itch, electric on the skin conditions are characterized by similar primitive levels.

Similarly, kinesthetic receptors in muscle spindles, tendons and joints are responsible for the perception of forces and displacement, measure as F_x, F_y, and F_z for forces and D_x, D_y, and D_z for displacement derivatives, and represented as symbols F and D, as shown in FIG. 11.

Complex haptic events during physical object interactions and manipulation consists of a combination of haptic primitives of FIG. 11. For example, when the user holds a tennis ball, the shape of the ball is measured by finger joint angles D and the grip force F. Surface of the ball is measured by finger indentations f_z and skin stretch f_x, f_y, and slip f_f. Individually, these primitives present a subset of ball holding experience, while combined together as a weighted function to produce the entire holding experience.

The haptic agent converts the raw sensor signal into haptic primitives and stores them in the haptic database for a particular haptic event. This process advantageously includes neural networks and transformers for processing, inference and generation. In addition to the sensor and primitive level data, the haptic database also include information related to sensor type (e.g. IMU, tactile sensor type, and the like), device type (chair, palm-band, and the like), mounting location on the body (back, palm, and the like), modality (senor input or feedback output), and the like to provide source data for both inferring and generation of haptic data.

The haptic agent processes the raw sensor signal and/or haptic primitives to infer events associated with user gestures, postures, and/or user states. For example, the sensor measurements associated with pressing on a soft sensor (shown in FIG. 2) indicate if the user presses to move a mouse cursor in one of the four cardinal directions (similar to the joystick) or pressures inward to move the cursor along the depth of the scene to represent a three-dimensional cursor movement using a single assembly. FIG. 2c shows the outcome of a convolution neural network (CNN) when the model is trained for pressure and four cardinal directions along the xy-plane (FIG. 2d).

Similarly, the haptic agent uses context level data from user applications, cloud or another device to infer higher order user states to make useful decisions. For example, the haptic agent instructs the users to adjust grip forces to maintain stability while performing tasks, or to adjust their sitting postures in order to distribute the sitting pressure uniformly on the hips rather than on lower spine.

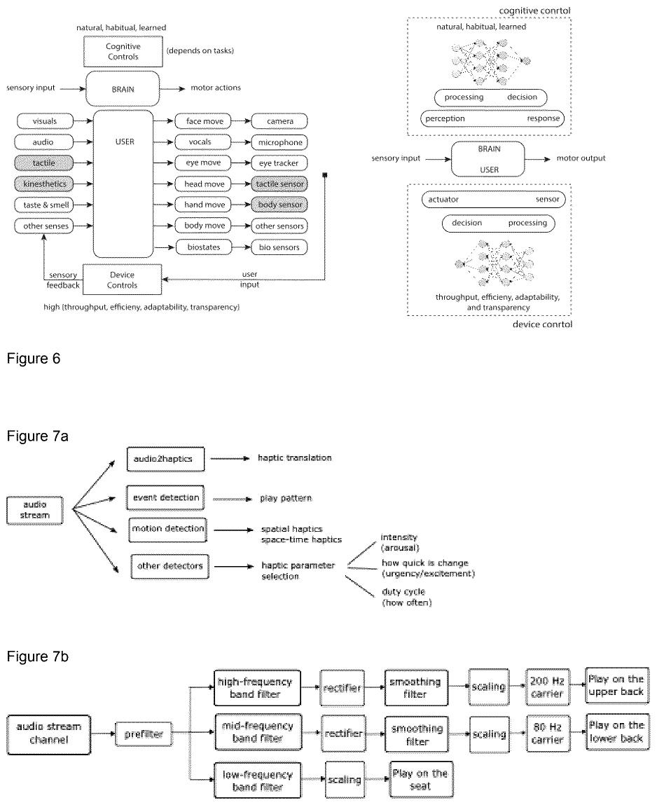

The haptic agent also learns user's internal controls models related to natural user behaviors while monitoring user actions through haptic sensors, see FIG. 6. One control method is where sensor input and health metrics generate haptic feedback, i.e. understand the user's physiological state and provide coherent and personalized haptic patterns (for example soothing or emotional stroking patterns). When a user interacts with a physical object, then tactile and kinesthetic sensors activate the perception block (somatosensory and motor cortex) and the processing block (memory and attentional resources) in the brain to infer a cognitive model of the physical task and environment (FIG. 6b). Based on the internal model of the user's nervous system (that are inherent or built over time by learning), the brain sets on a decision to maximize the reward and recruits a series of subsequent actions to trigger motor commands for the body. The haptic agent learns user actions and behaviors for a given context (or task), and determines a set of haptic feedback (the policy) to maximize user efficiency for a given context.

The haptic agent is trained on many trials when the user interacts with the real physical objects to learn the optimal policy of the feedback system, and then using this policy to recreate those behaviors in virtual environments. These control models create natural user experience in digital virtual environments by artificially producing the optimal feedback synchronized with user actions and behaviors. These models are also used in autonomous robots to learn and perform tasks similar to users.

The haptic agent has a versatile Generative Model that accounts for user context, multimodal inputs and perception-based models to generate believable and intuitive haptic feedback based on the given haptic device technology. The agent generates haptic feedback corresponding to user prompts in the form of text, voice and videos, audio streams, video streams and user action streams. For illustration, we show the implementation of the generative models on either multidimensional haptic device (FIG. 3) or multichannel haptic device (FIG. 4).

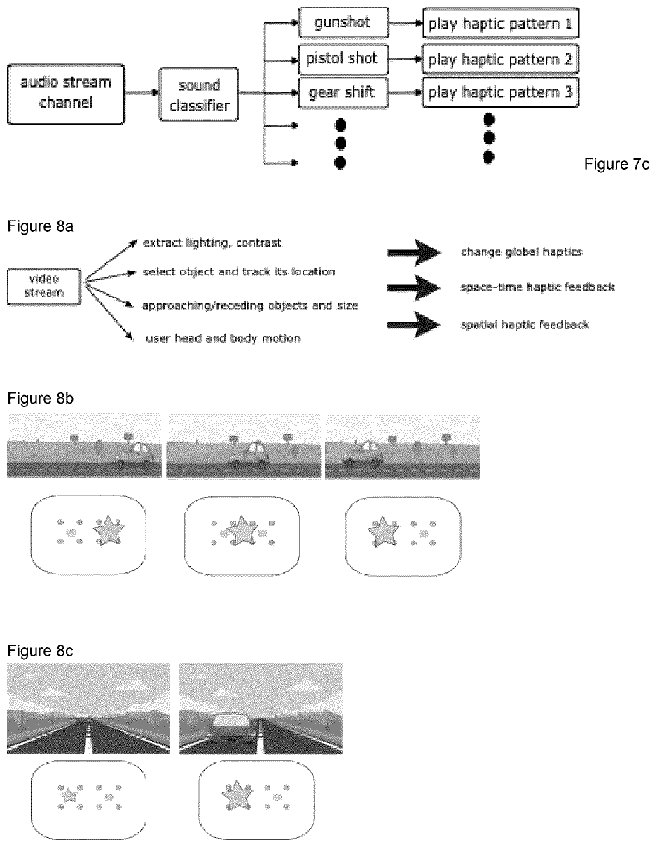

Audio Streams: The generative model extracts temporal and spectral features from the audio streams and maps them onto the multichannel haptic device of FIG. 4. The overall mapping is shown in FIG. 7a. The audio stream is passed through i) an audio-to-haptic translation scheme to directly translate spectral features to the haptic device (FIG. 7b), ii) an event classifier to play predefined haptic patterns on audio events (FIG. 7c), iii) a spatial haptic scheme that preserves the location of audio on user body, and iv) a parameters GUI to adjust the quality of haptic experience.

In audio-to-haptic translation scheme, FIG. 7b, the audio signal is first passed through a pre-emphasis filter that amplifies the energy above 1000 Hz at a rate of 6 dB per octave in order to compensate for the falling energy at higher frequencies. The filtered signal is then passed through three band-pass filters to extract low-, mid-, and high-frequency bands. The bands are selected for 20 Hz-250 Hz for low-frequencies, 250 Hz-1000 Hz for mid-frequencies, and 1000 Hz-10000 Hz for high-frequencies. The low-frequency signal is scaled to match with human sensitivity and directly passed to the actuators on the seat of the device. The mid-and high-frequency signals are rectified, passed through a 20 Hz smoothing filter, scaled to match human sensitivity, driven by a carrier frequency of 80 Hz and 200 Hz, respectively, and played on the actuators on the lower-back and upper back, respectively.

The audio stream is passed through an event classifier that detects a set of typical events from the audio stream and plays predefined haptic patterns on the multichannel haptic device (FIG. 7c). The classifier is trained on subset of sound from the games associated with events, and associate the events with a haptic pattern from the users'library.

The audio stream is made spatial by passing the left audio stream to the left side of the device and the right audio stream to the right side of the device. In addition, the low-frequency envelopes (e.g., from engine rumbles, bass, drum sounds) are mapped to the seating area, while high frequency envelopes are mapped to the upper body area (FIG. 7b). The spectral intensities are scaled to the intensity of haptic actuators. This is more natural for users as they are more familiar with rumbles through the base of seats in cars, trains, theater seats, airplanes, and the like While reverberations from the back. This way, as the dominant frequency of the audio signal increases from low-frequency to high-frequency, the users feel haptic patterns moving from the seat to the upper back. In addition, the haptic patterns are auto adjusted based on the user's sitting position. As the user tilts to the left (or right) then the left activation patterns are always played on the left of the user body, and vice versa.

Haptic events are also adjusted based on a set of user controlled GUI settings (FIG. 7a). The arousal setting sets the overall intensity of haptic patterns, higher arousal results in higher intensity. The duty cycle setting is adjusted to control the number of haptic events, higher duty cycle increases the number haptic events per unit time. The excitement setting adjusts the rate at which the haptic patterns are onset or decayed, higher excitement corresponds to quick change.

Video Streams: The generative model extracts object and motion features from the video and plays them as haptic signals (FIG. 8a). The video streams are processed by a classifier and each object, their behaviors and movements are tracked by the agent. The agent then maps these features to the grid of the multichannel haptic device. FIG. 8b shows the process of extracting the location of a car in a frame and updating it in every frame as the car moves from right to left. Consequently, the haptic patterns vibrate the right side of the multichannel device and subsequently the patterns move from right to left corresponding to the location of the car on each frame. Similarly, in FIG. 8c, the haptic agent extracts the location and size of an approaching car and the corresponding haptic pattern increases in size to give the user an approaching object towards them. The location of the haptic pattern is updated depending on the location of the user, detected by the sensors in the seat, and also the viewing angle of the head so the haptic patterns are “spatial”.

The lighting and contrast features from the game are captured by analyzing and comparing each pixel of the video frame and map to the carrier frequency of the haptic signal, frame by frame. Bright frames are played at 250 Hz while dark frames are played at 40 Hz haptics signal. Intermediate levels are interpolated between 40 Hz and 250 Hz. Overall high contract hues are played with high intensity and low contracts are played at low intensity vibrations.

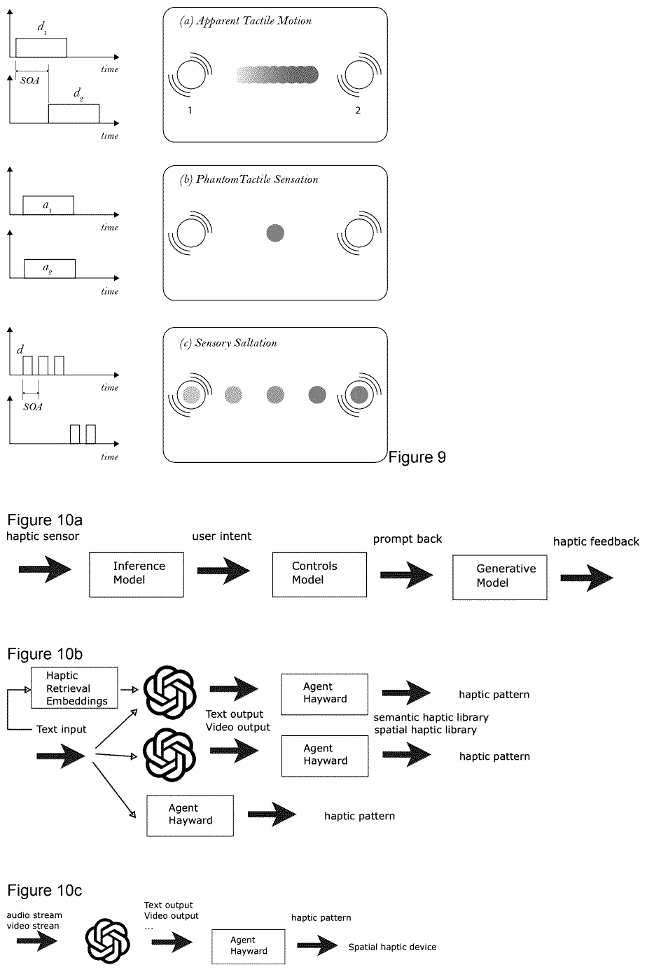

FIG. 9 shows three haptic illusions used by the generative model of the haptic agent. When the two vibration points are played in successive order with an optimal stimulus-onset-asynchrony (SOA) then the user feels continuous motion between the two vibration points, and the speed of the motion varies with SOA (shorter SOA results in faster motion). This illusion is called Apparent Haptic Motion. When the two vibration points are played simultaneously, then the user feels a virtual vibration between the two points, where the location and intensity of the vibration points depend on the intensity of the two vibration points. This illusion is called Tactile Phantom Sensations. When the three brief vibrations are successively played on one vibrator followed by three brief vibrations on the other vibrator, then the user feels vibrations hopping from one point to the other. This illusion is called Tactile Saltation. These space-time haptic illusions are modeled and programmed in the haptic agent to generate high-resolution dynamic moving sensations on a scarce grid of multichannel haptic device (FIG. 4).

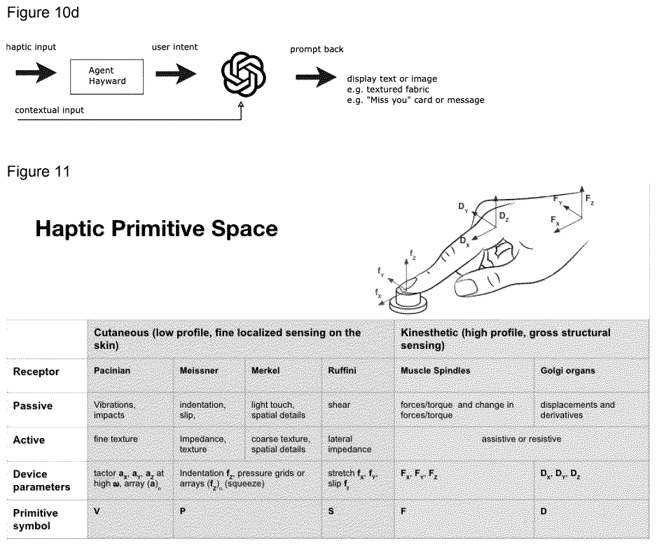

The haptic agent also generates haptic patterns directly from user actions. Haptic sensors capture user activities, which are processed by the inference models to determine user actions, postures and gestures (FIG. 2d). The user actions are then passed through control models to prompt optimal haptic actions which are then passed through the generation model to generate corresponding haptic output on the device (FIG. 10a).

The haptic agent also interacts with the Large Language Models (LLM). A user enters the prompts which pass through Haptic Retrieval Embeddings before being processed by LLMs to generate text, audio or video outputs from the models. These outputs are passed through the haptic agent (haptic semantic library, video2haptic or audio2haptic models) to auto generate haptic patterns on the device (FIG. 10b). Similarly, video and audio prompts are directly processed by LLMs and then passed through the haptic agent to translate audio-video feeds to haptic streams (FIG. 10c). Finally, haptic inputs from sensors are processed to determine user intents. Combined with other multimodal contextual inputs the LLM prompts back with haptic or multimodal output (FIG. 10d).

### Scalability and Applications

A subset of HW components and SW components are put together in another device, which has access to the user's inputs and feedback. The HW-SW components are placed in a user device or in a remote device. Either the user or the remote device has master control settings (such as when two users remotely interact with each other then the master control vary haptics one at a time, or during robotic manipulation where the user has master control and the remote robot has slave mode unless the operator redefines it), or the user device has master settings and the slave device has slave settings (for example in the case of robotic learning).

A subset of HW components and SW components in a device senses, classifies and tracks user's sitting postures, as if they are sitting upright, sideways, pushing the back seat, slouching, or lying down, and the like The device recognizes user postures, displays analytics for user sitting trends, and provides instructions for users to correct and maintain their sitting posture.

A subset of HW components and SW components in a device senses, classifies and tracks sitting postures and body gestures for multiple users.

A subset of HW components and SW components in a device senses user body states and movements, and produce “spatial” haptic experience corresponding to the content of a game. Audio of the game is mapped to haptics using audio-stream translation schemes (FIG. 7) and video-streams are translated to spatial and space-time haptic translation schemes (FIG. 8). These translation schemes are also used with movies and shows to auto-generate multisensory immersive experiences in theaters, rides, shows, home entertainment systems, living room couches, office chairs, vehicle seats. Similar devices are used for motion sickness alleviation at home or during moving vehicles by mapping motion cues spatially on the skin using algorithms in FIG. 9.

Haptic inferring and generative models (FIG. 10a-d) are used in a haptic communicator to code emails and messages as tactile pulses for discreet and uninterrupted input to users. Users can learn tactile codes to convey complex sentences and context level information. These communicators are useful for normal and sensory impaired users-the latter can use them for hearing stories, reading news, watching movies and sporting events with skin.

Haptic communicators are used to detect tactile pressures and generate them remotely. Such systems are useful for robotic and virtual training, teleoperation and remote manipulations, and for 2-way social touch communication to convey non-verbal natural touch essential for creating and maintaining strong interpersonal bonds amongst humans.

### SUMMARY OF DRAWINGS

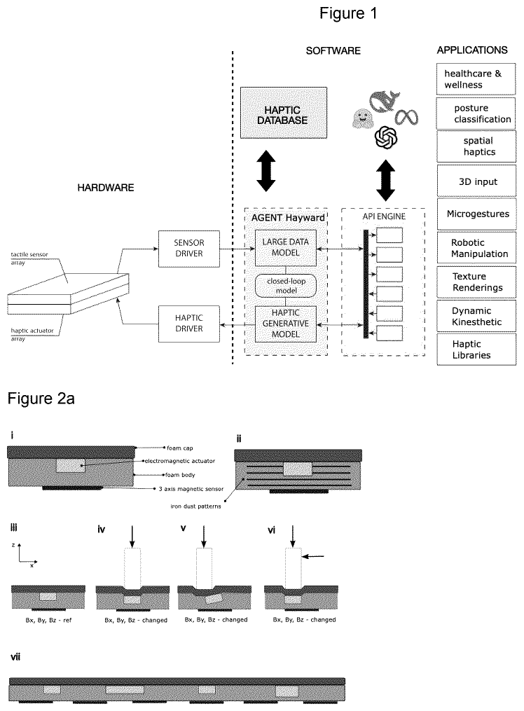

FIG. 1: Flow of haptic information in a multimodal system from the hardware system (left, the haptic device) to software processes (shaded blocks) and back to the hardware system. The software block provides an API to connect to other systems, cloud to build on user applications.

FIG. 2a: The configuration of haptic actuators and haptic sensors packaged in soft foam structure. The actuator deforms due to external loading, varying the magnetic field captured by a 3D magnetic sensor.

FIG. 2b: A Method to fabricate haptic actuators and haptic sensors is a soft foam assembly.

FIG. 2c: A model of 3D magnetic flux as a function of deformation penetration in perpendicular and lateral directions.

FIG. 2d: the outcome of a convolution neural network when the model is trained for the 3D magnetic flux signal per Z-pressure (CENTER) and four cardinal directions along the xy-plane.

FIG. 3: multidimensional configuration of the palm band device (a) and (b).

FIG. 4: multichannel configuration of the chair device (a) and (b).

FIG. 5: The flow of haptic information from a hardware device to software and applications.

FIG. 6:(a) Haptics controls model for Agent Hayward. (b) Framework of a neural network model to train on sensor inputs (inference models) and generate haptic outputs (generative models).

FIG. 7a: Haptics Generative Model for audio streams.

FIG. 7b: Direct audio to spatial haptics translation scheme.

FIG. 7c: Events are classified from the sound and mapped to haptics patterns.

FIG. 8a: Haptics Generative Model for video streams.

FIG. 8b: Tracking the location of an object on the screen maps to spatial haptics by preserving the location on the user's body.

FIG. 8c: Tracking the size of an object on the screen maps to the size of a haptic impression on the user's body.

FIG. 9: Illusory models in haptic perception to generate high resolution haptic patterns on sparse grid of actuators.

FIG. 10a: Auto generated haptic content from user action (from haptic sensors) streams.

FIG. 10b: The haptic agent interacts with the Large Language Models (LLM) to auto generate haptic pattern packages.

FIG. 10c: The haptic agent translates audio-video feeds to haptic streams (FIG. 10c).

FIG. 10d: The flow of data with haptic inputs from sensors to determine the user's intent.

FIG. 11 Haptic primitives for the physical feelings of vibration, pressure, force and deformation, and associated nerve endings triggering the physical response.

### SUMMARY OF CLAIMABLE SUBJECT MATTER

Multimodal systems, where the input of the system are audio, videos and other media streams, user inputs including actions, prompts and speech, and the context of the user and the environment, and the output of the system is the haptic data felt as a percept on the body judged by a user(s). Haptic data is played (or rendered) on haptic transducers (or haptic channels) arranged in a spatial layout on and around the user(s). (For example, one on the desk, an array in a seat.) Haptic data varies in time and with context, is composed of primitive haptic units of vibrations, pressure, shear, impedance, and/or thermal quantities (e.g. their parameters are frequency, amplitude, torque, temperature, and the like), and is defined by the characteristic nature of the transducer (or haptic channel) (e.g. VC, motor, for mechanical, and the like). (This defines relationship between the transducer or device and haptic primitive units. See Table 1.) Haptic data accommodates (or derived from) perception based models that produce/render characteristic feelings on a transducer or set of transducers. These characteristic feelings are described by a phrase, expression, or an experience by a set of users, and could be part of their vocabulary, skills or something that is learnt over time. (This connects haptic primitives with perception and cognition semantics as judged by users; or patterns easily differentiated and recalled.) Haptic data is captured by the same transducer or another set of sensors placed within the same device or another device. Haptic data is further used to understand user states. For example, pressure sensitive transducers placed in the seat track sitting postures, and the like A piezoelement used for haptic actuation is also used to measure mechanical deformations due to the user force. In our case, we used an array of 3D magnetometers (TLV493D) to measure magnetic field change due to displacement of the motors. Haptic transducers are placed in a device or set of peripheral devices that are individually powered and wirelessly connected. The device(s) are worn by the user, or held against the skin as in watches, handhelds or furniture. Haptic data is rendered to the analog world via PWM or DAC, at refresh rates between 1000-4000 Hz and with 12-16 bit of quantization resolution. A CPU provides compute, memory, and communication such as Serial/USB, I2C, BT/WiFi. Haptic sensor input detects sitting posture and adjusts haptic output data accordingly. For example, as the user body rotates, tilts or slouch, then the corresponding spatial nature of the media is preserved with haptic rendering algorithms. A library of haptic activation patterns is defined in a Haptic database. These patterns are uploaded and played on haptic transducers to create a predefined percept on the user skin.

The multimodal input is analyzed, processed and mapped to the haptic data. The main purpose of the processing is to extract spatial and context information from the media and detect if specific events occur.

### Audio Multimedia Input

Audio signals are processed through bandpass filters and spectral signals are directly mapped to channel's or channels'primitive parameters. For example, low-frequency audio is mapped to the amplitude of the haptic channels(s) on the bottom left corner of the device. A frequency-to-place scheme is defined and implemented, where low frequencies are mapped to one end and the high frequencies are mapped to another end of the device. The left-right audio is mapped to the left-right channel. Similar techniques have been applied for tactile aids, gaming chairs, XR devices and the like in the last 50 or so years. Audio signals are processed and classified to extract speech, events, objects and their movements and mapped to user-defined activation patterns on haptic channels. User voice is extracted from the audio signal and mapped to the haptic data. Videos are processed at the pixel level in each frame and brightness and contrast of a region or regions in a frame are mapped to the haptic data (either to specific actuator or a region of actuators based on spacetime and/or semantic symmetries). Objects in the video are detected based on their shape, size or color, and tracked using feature extraction and prediction algorithms. Objects and their movements are mapped to the haptic data. Videos are processed to detect and classify events and mapped to user-defined activation patterns on haptic channels. Body movements and skin deformations are sensed by on-board sensors (IMU, strain gauge, magnetic pressure sensors which detect and track user postures, gestures, movements and pressure, and map them to the haptic data. User inputs such as text, voice, and actions (press, slide, and the like) intervene between media inputs and haptic out, allowing users to customize haptic data defined by user prompts. A system prompt defines the configuration of the haptic device, including number, type and location of transducers in the device, and the dynamic range, jnds, and primitive activation patterns for the device. For example, primitive parameters can be a Feel Effects Library (https://la.disneyresearch.com/publication/feel-effects/) that associates characteristic feelings to primitive haptic units (device parameters). These associations are inserted as “few shot prompts” in the system prompt. System prompts act as a guide for the AI's identity, role, expertise, tone, and boundaries. System prompts are specific to a device and available in the Haptic Database. A selection prompt defines bounding boxes around objects-of-interest at user-selected frames of the input media (see inset in FIG. 1). A pop-up dialog box appears for the user to define a behavior of tracking algorithms in between the selected frames. (e.g. increase the size of the object by a factor 2 or 2*(t)) This could be applied by the user to use gestures to select “start” and “end” of the recording frame. If no selection is defined then the whole media stream is processed with default levels.

### LLM/GPT

User prompts and system prompts are passed through a large language model in order to translate user language (user prompts) to device parameters. Large Language models are trained on new data detailing relations between haptic data, haptic primitives, device parameters, user language and the perception of feelings as judged by users (annotated with text). This fine tunes the large language model for generating customized haptic data for transducers used in the haptic device(s). This is defined by the system prompt, and potential extension to RAG (Retrieval-Augmented Generation). The large language model outputs an array of parameters for each transducer (channel), termed as “Haptic Semantic Filter” (or a haptic Kernel). User inputs, media inputs, and the context are processed together, some features are weighted low and some are weighted high based on the embeddings defined in the model. The output of the detection and tracking algorithms are “convolved” with the Haptic Semantic Filter, and therefore, maps objects or events of the input media to the haptic device space.

The convolved output (resulting from the content in the media and user prompts) is translated to the haptic data through the Haptic Rendering Algorithm Engine. These rendering algorithms are explained herein. Barycentric triangulations are used to convert high resolution visual pixel arrays to low resolution haptic transducer arrays. The weights of the coordinates are optimized based on the body location, type of device, and context of interactions, and context of the visual object. This method is frequently used with spatial grid displays. HDT calibrated functions map the convolved output to the dynamic range of the haptic perception rendered on a transducer/device. This is calculated as: Where, Iin is the intensity (convolved output, e.g., size) of the tracked object between 0 to Imax, IdB is the corresponding mapping between 0-dBmax scale, and IHDT is the intensity of the haptic data between T0−Tmax. Tmax is limited to the comfortable intensity or saturation limit of the DAC. ?? is the empirical value calculated for a device and body location. For the back, we use ??=2.3025. f is the frequency or speed, and fD is the bandwidth of the device. It is known that the threshold T0 varies with the rate of stimulation (e.g. with frequency in vibrations) so the threshold function could to be compensated as in Israr et al. 2004. Perception based models: Motion and Force based perception functions are defined. Motion based models: Amplitude of each transducer are systematically modulated to render three popular illusions, i.e., Apparent Movements, Saltation, Phantom Illusions. These illusions render expressive features to the haptic data associated with movements, direction, quality, and the like Mathematically,, for all i in channels. HD is the haptic data. Force based models: A “hardness” model (i.e.,) is defined as the quantity of force, F, rendered by a device at given deflection, d. The constant K is the hardness coefficient. High K makes objects stiff and hard, while low K renders soft objects. A variable K(d, t) is also used for different deflection levels and time to create perceptions of “fluidic”, “rough”, “button press”, and the like This could be a totally different patent. More information from the handheld tests and studies, if needed. Agent based models are trained for user gestures and movements. They analyze real time input and media streams and render haptic feedback with latency of 100 milliseconds to close the sensory-motor action-conformation loop. This improves immersion and efficiency while users interact with virtual objects with their hands and bodies. Gesture models are classified using the University of Washington gesture classification model. Based on the gesture and context logic, a haptic pattern is rendered from the Haptic Library that reduces user uncertainty and increases efficiency. This is ongoing work. Spatial Haptic Algorithm: the quality of haptic output data is adjusted based on the haptic input. For example, the sitting posture (whether the user is sitting upright or sideways) is detected by haptic input data. The corresponding haptic output data is scaled and rotated to accommodate the change in users'viewing angle.

### Haptic Database and Library

Device library: Various device databases. (configuration of the haptic device, including number, type, location, dynamic range, jnds, configuration and contextual parameters of transducers.) Haptic effects Library (predefined): A predefined set of haptic effects for a variety of devices and associated semantic labels describing them. Parametric Haptic Effect databases: A database of parameters and families of haptic effects. For example, the Rain family has parameters (number of drops per min, size of the drop, and the like) labeled as ‘light’ and ‘heavy’ rain. With a contextual logic, the parameters are adjusted. So instead of storing and processing the complete haptic pattern, only a set of parameters are stored and processed. An additional Haptic Algorithm (runs in the haptic engine) renders the haptic data. Examples are, single bump, double bumps, engine, heartbeat, motion left, rain, and the like. Haptic algorithms are documented with source codes, research articles and corresponding links to databases.

Authoring System: FIG. 1 shows generation of haptic content, where input media is applied to AI to autogenerate haptic data on a device. Users intervene and modify haptic data as their likings which are described by their language (prompts, speech) or actions. An interface on which users select a device, input media and algorithms, and play haptics. Users select patterns from a library and play them, edit them, share them or save them as new patterns or presets with labels. A number of UI tools (sliders, buttons, knobs, and the like) are provided for users to adjust patterns (through parametric mapping of Haptic Effects). A user traces a line path (straight, circular or free form) on a top of the grid layout; edits the thickness, color and continuity; augments the line with special haptic effects (e.g. flamy or pulsating lines are set by modulation parameter); plays on the device, edits it their liking, saves it or shares it.

### Device System

The device can render a single channel vibration, multichannel vibrations, multichannel pressure, and can be multidimensional (having more than one haptic primitive). The device is connected to the cloud and internet, loads databases and patterns, receives commands and sends data and commands to established two way communication. The device firmware is updated Off-the-air and/or through a USB port of a computer with the latest instruction code for one or many devices in the system. Two form factors to secure: one is in the furniture category, the HapticSofa. The location and type of haptic transducers are optimized based on the skin's sensitivity on the back and the seat. More information in the provisional patent. Key innovations are grid haptic displays as space-time haptic displays; location and type of transducers based on sensitivity metrics; transducer mounting mechanisms and paddings to optimize haptic response and structural resonance. Custom sensors in the sofa to understand users'sitting conditions and haptics are played when the sensor measurements are above a threshold. The second category is in the wearable XR domain, the PalmCuff. The location and type of haptic transducers are optimized based on the palm's sensitivity, hand's functionality and anatomy. More information in the provisional patent. Key innovations are IMU for hand tracking, StretchHaptic and Broadband/Pulsating Haptics as multidimensional haptics. The input media is audio, video, actions, and other media streams. These streams are captured using microphones, cameras, IR sensors, IMU, pressure sensors, EMG, PPG, and the like or digitally synthesized.

I claim:

1. A device adapted to render a single channel vibration, multichannel vibrations, or multichannel pressure, wherein the device is interconnected with the cyber cloud and is adapted to load databases and patterns, receive commands and send data and commands to established two way communication; and further wherein the device further comprises programmable firmware to enable these functions.

2. A device adapted to render a single channel vibration, multichannel vibrations, or multichannel pressure and concurrently sense pressure from one localized sensor or multiple sensors, wherein the device is interconnected with the cyber cloud and is adapted to load databases and patterns, receive commands and send data and commands to established two way communication; and further wherein the device further comprises programmable firmware to enable these functions.
